(19) United States
(12) Patent Application Publication
(10) Pub. No.: US 2026/0004965 A1
(43) Pub. Date: Jan. 1, 2026

(54) COIL DEVICE

(71) Applicant: TDK Corporation, Tokyo (JP)

(72) Inventors: Satoshi SUGIMOTO, Tokyo (JP); Tomoya Ishihara, Tokyo (JP); Kosuke Endo, Tokyo (JP)

(73) Assignee: TDK Corporation, Tokyo (JP)

(21) Appl. No.: 19/236,391

(22) Filed: Jun. 12, 2025

(30) Foreign Application Priority Data
Jul. 1, 2024 (JP) 2024-106324

(51) Int. Cl. H01F 27/30

(52) U.S. Cl. CPC H01F 27/30

(57) ABSTRACT

A coil device including: a core part including a metal powder and resin, a first conductor including a first coil part inside the core part, a first mounting part at least partially exposed from the core part and faces a mounting object, and a first connecting part connecting the first coil and first mounting parts, a second conductor including a second coil part inside the core part, a second mounting part at least partially exposed from the core part and faces the mounting object, and a second connecting part connecting the first coil and first mounting parts, wherein; a groove forms to the first coil part inner surface along a winding direction, the second coil part extends along the first coil part winding direction inside of the first coil part, and the second coil part is at least partially arranged inside the groove of the first coil part.

### CROSS-REFERENCE TO RELATED APPLICATIONS

This application claims priority to Japanese patent application No. 2024-106324 filed on Jul. 11, 2024 which is incorporated herein by reference in its entirety.

### BACKGROUND

The present disclosure relates to a coil device used as inductors for low voltage and high current use.

There are increasing demands in coil devices for low voltage and high current use which are used as TLVR circuits or so. Regarding the coil device for low voltage and high current use, a coil device shown in Patent Document 1 is proposed as an example. Note that, conventional coil devices had problems such as a space being formed between a first conductor and a second conductor arranged inside a core, and a production variance happening upon setting the positions of the first conductor and the second conductor. For example, if magnetic materials entered inside the space formed between the first conductor and the second conductor, this will impact a coupling between the first conductor and the second conductor (lowers a coupling coefficient). Also, when a position accuracy between the first conductor and the second conductor is low, it has an impact on a performance of the coil device. As such, position variations such as whether the space exists or not and the size of the space between the first conductor and the second conductor may interfere from achieving a coil device with higher performance in some cases.

### PRIOR ART DOCUMENT

### Patent Document

Patent Document 1: JP Patent Application Laid Open No. 2022-33703

### SUMMARY

In order to achieve the above-mentioned object, the coil device according to the present disclosure includes:
a core part including a metal powder and a resin;
a first conductor including a first coil part arranged inside the core part, a first mounting part at least partially exposed from the core part and faces a mounting object, and a first connecting part connecting the first coil part and the first mounting part; and
a second conductor including a second coil part arranged inside the core part, a second mounting part at least partially exposed from the core part and faces the mounting object, and a second connecting part connecting the first coil part and the first mounting part;
wherein, a groove is formed to an inner surface of the first coil part along a winding direction,
the second coil part extends along the winding direction of the first coil part at an inside of the first coil part, and
the second coil part is at least partially arranged inside the groove of the first coil part.

### BRIEF DESCRIPTION OF DRAWINGS

FIG. 1 is an oblique view of a coil device according to an embodiment of the present disclosure which is viewed from diagonally below.

FIG. 2 is an oblique view of the coil device shown in FIG. 1 which is viewed from diagonally above.

FIG. 3 is a bottom view of the coil device shown in FIG. 1.

FIG. 4 is a first cross-section of the coil device shown in FIG. 1.

FIG. 5 is a second cross-section of the coil device shown in FIG. 1.

FIG. 6 is an oblique view showing a first conductor and a second conductor of the coil device shown in FIG. 1.

FIG. 7 is a perspective view showing the second conductor of the coil device shown in FIG. 1.

FIG. 8A is a conceptual view showing a coil device according to the first modified example.

FIG. 8B is another conceptual view showing a coil device according to the first modified example.

FIG. 8C is another conceptual view showing a coil device according to the first modified example.

FIG. 9A is another conceptual view showing a coil device according to the second modified example.

FIG. 9B is a conceptual view showing a coil device according to the second modified example.

FIG. 9C is another conceptual view showing a coil device according to the second modified example.

FIG. 10A is a conceptual view showing a coil device according to the third modified example.

FIG. 10B is another conceptual view showing a coil device according to the third modified example.

FIG. 10C is another conceptual view showing a coil device according to the third modified example.

### DETAILED DESCRIPTION

In below, embodiments of the present disclosure are described.

### First Embodiment

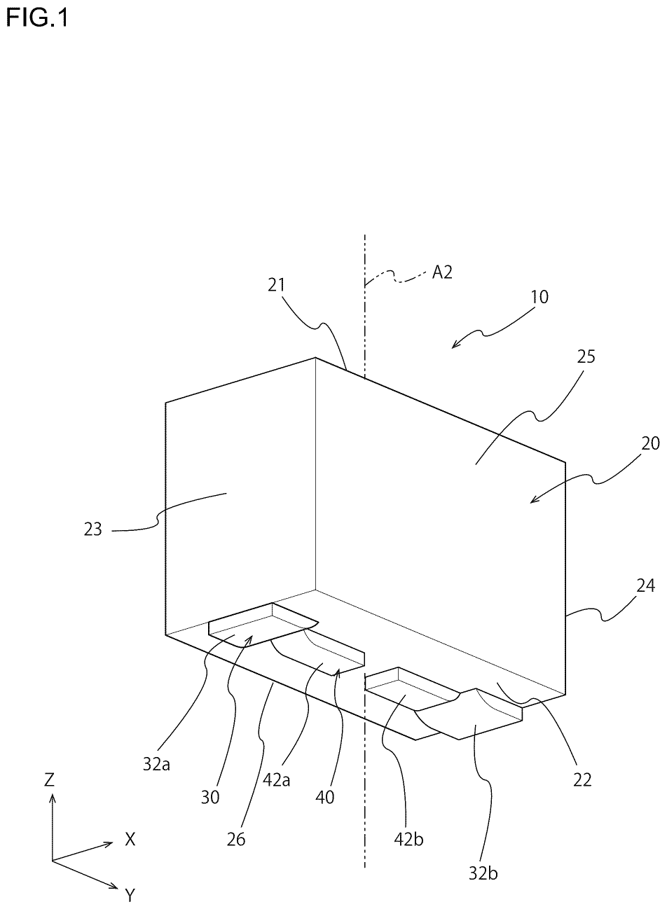

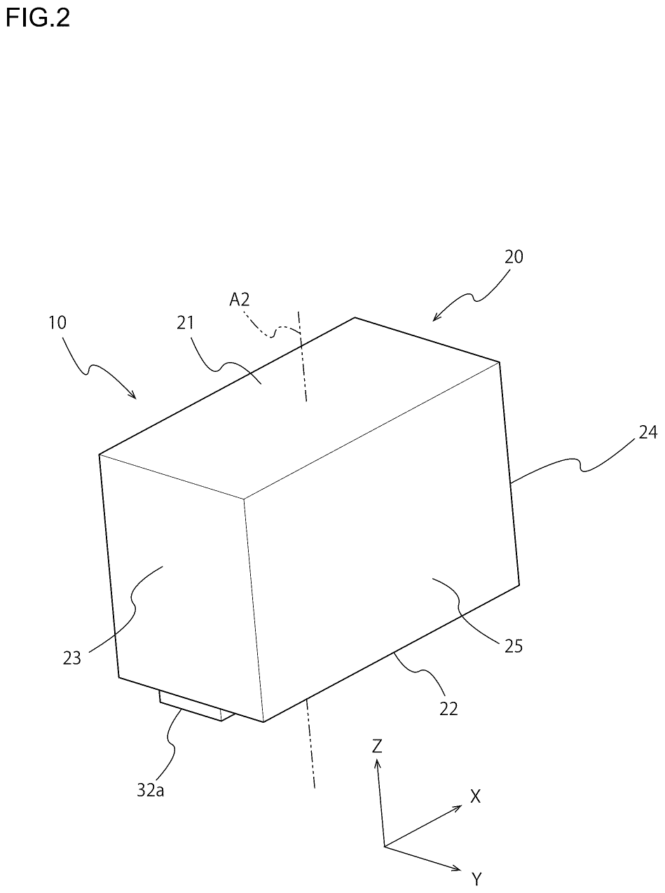

As shown in FIG. 1 and FIG. 2, a coil device 10 according to the present embodiment is roughly a rectangular parallelepiped shape, and it is used as a coil device for low voltage and high current use which is used for TLVR circuits, etc. A dimension of the coil device 10 is, for example, an X-axis direction width of 3.0 to 12.0 mm, a Y-axis direction width of 3.0 to 6.0 mm, and a Z-axis direction width of 3.0 to 12.0 mm. Note that, in the figures, X-axis, Y-axis, and Z-axis are approximately perpendicular to each other. In the present embodiment, the Z-axis coincides with a height direction of the coil device 10. Also, in the below description, a direction toward a center of a member (such as a center of the coil device 10) along each axis is defined as an inner side, and a direction away from the center is defined as an outer side.

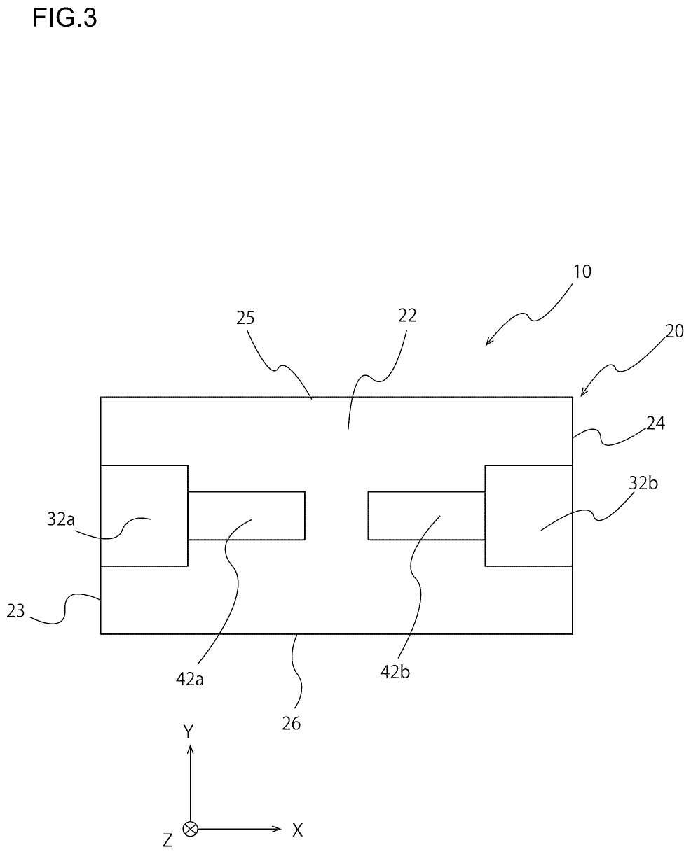

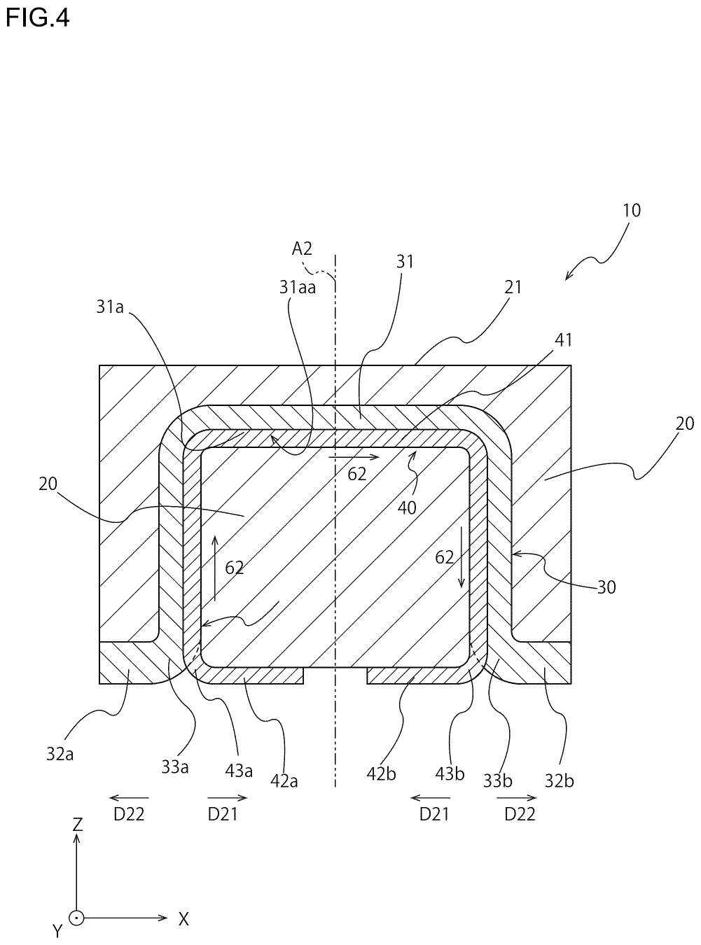

As shown in FIG. 1 to FIG. 3, the coil device 10 includes a core part 20 including a metal powder and a resin, a first conductor 30, and a second conductor 40. The first conductor 30 includes two first mounting parts 32a and 32b which are at least partially exposed from the core part 20. The second conductor 40 includes two second mounting parts 42a and 42b which are at least partially exposed from the core part 20. In the coil device 10, the first conductor 30 which is arranged at the outer side in relativity functions as a primary coil, and the second conductor 40 which is arranged at the inner side in relativity functions as a secondary coil. Note that, whether to use the first conductor 30 and the second conductor 40 as the primary coil or the secondary coil may be changed depending on the use of the coil device 10; and the coil at the inner side may be used as the primary coil and the coil at the outer side may be used as the secondary coil. The first conductor 30 and the second conductor 40 will be described in detail later using FIG. 4 to FIG. 7.

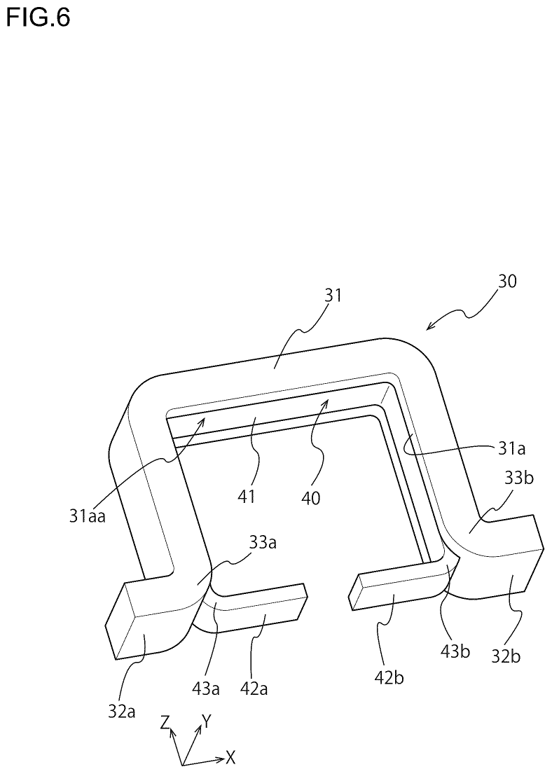

For example, a raw material powder obtained by mixing a metal powder and a resin is compress molded using a mold in which the first conductor 30 and the second conductor 40 are arranged as shown in FIG. 6; thereby, the core part 20 may be obtained. Examples of the metal powder include (a Fe—Ni alloy powder), (a Fe—Si alloy powder), (a Fe—Si—Cr alloy powder), (a Fe—Co alloy powder), (a Fe—Si—Al alloy powder), and (an amorphous iron); and, the metal powder is not particularly limited to these. Examples of the resin included in the core part 20 include (an epoxy resin), (a phenol resin), (a silicon resin), and (other synthetic resins); and, the resin is not particularly limited to these.

As shown in FIG. 1 to FIG. 3, the core part 20 has an outer shape of roughly a rectangular parallelepiped shape. An outer surface of the core part 20 includes a core upper surface 21, a core lower surface 22, a first outer lateral surface 23, a second outer lateral surface 24, a third outer lateral surface 25, and a fourth outer lateral surface 26. As shown in FIG. 1, on the core lower surface 22 facing downward, the first mounting parts 32a and 32b which are parts of the first conductor 30, and the second mounting parts 42a and 42b which are part of the second conductor 40 are exposed. Among the outer lateral surfaces of the core part 20 other than the core lower surface 22, that is, the core upper surface 21, the first outer lateral surface 23, the second outer lateral surface 24, the third outer lateral surface 25, and the fourth outer lateral surface 26 are flat surfaces.

FIG. 4 is a first cross-sectional view of the coil device 10 shown in FIG. 1, and it is a cross-sectional view observing the coil device 10 from a cross-section which is parallel to the X-axis and including a device center axis A2 parallel to a height direction (Z-axis) passing through the center of the coil device 10. As shown in FIG. 4, the first conductor 30 includes a first coil part 31 arranged inside the core part 20, the first mounting parts 32a and 32b at least partially exposed from the core part 20 and face toward the mounting object, and first connecting parts 33a and 33b which connect each of the first mounting parts 32a and 32b with the first coil part 31.

FIG. 6 is a schematic oblique view showing the first conductor 30 and the second conductor 40 included in the coil device 10 shown in FIG. 1 to FIG. 3. As shown in FIG. 6, the first conductor 30 and the second conductor 40 inside the core part 20 are arranged so that the second conductor 40 is partially embedded in a groove 31aa formed to an inner surface 31a of the first coil part 31; thereby, the first conductor 30 and the second conductor 40 are in a condition where these are engaged with each other.

As shown in FIG. 4 and FIG. 6, the first conductor 30 has a shape which is raised upward when viewed from the Y-axis direction. For example, the first conductor 30 can be produced by mechanically processing metal rods and flat wires, and a method for producing the first conductor 30 is not particularly limited. Examples of materials of the first conductor 30 include good conductor metals such as copper, iron, gold, silver, aluminum, and alloy of these; and the materials are not particularly limited to these as long as it can function as a current pathway of the coil device 10.

Also, although it is not shown in FIG. 4 and FIG. 6, on the surface of the first conductor 30, an insulation coating such as a resin may be formed. Note that, at the part where the first conductor 30 and the second conductor 40 are adhered as shown in FIG. 6, an electrical insulation is secured using the insulation coating or an adhesive cured part, which is described later, on the surface of the first conductor 30 and the second conductor 40. Note that, the insulation coating of the first conductor 30 is not formed on the lower surfaces of the first mounting parts 32a and 32b.

As shown in FIG. 4 and FIG. 6, the first mounting parts 32a and 32b which are included in the first conductor 30 are respectively arranged at one end and the other end in the Y-axis direction of the first conductor 30. Also, the first coil part 31 included in the first conductor 30 is arranged at a center part in the Y-axis direction of the first conductor 30.

The first coil part 31 has an outer shape which is a U-like shape opened downward when viewed from the Y-axis direction. The first coil part 31 surrounds the center area of the coil device 10 from three-directions which are the upper side, and both lateral sides of the X-axis direction.

The first mounting part 32a configuring the end part in the X-axis negative direction of the first conductor 30 is connected to the end part of the first coil part 31 in the X-axis negative direction and the lower direction (Z-axis negative direction), and a first connecting part 33a exists between the first mounting part 32a and the first coil part 31. The first connecting part 33a is bent, and the first mounting part 32a connected to the first connecting part 33a extends toward a device outer side direction D22 with respect to the first connecting part 33a connected to the first coil part 31.

The first mounting part 32b configuring the end part in the X-axis positive direction of the first conductor 30 is connected to the end part in the X-axis positive direction and the lower direction (Z-axis negative direction) of the first coil part 31, and a first connecting part 33b exists between the first mounting part 32b and the first coil part 31. The first connecting part 33b is bent, and the first mounting part 32b connected to the first connecting part 33b extends toward the device outer side direction D22 with respect to the first connecting part 33b connected to the first coil part 31. Note that, the first conductor 30 has a symmetric shape across the device center axis A2.

As shown in FIG. 4 and FIG. 6, at the inner surface 31a of the first coil part 31 and the first connecting parts 33a and 33b, the groove 31aa is formed along the winding direction 62. The groove 31aa is formed along the shape of the winding direction 62 of the first coil part 31, and a depth of the groove 31aa is roughly consistent along the winding direction 62. The lower end parts of the groove 31aa continues to the inner surfaces of the first connecting parts 33a and 33b, and the groove 31aa is opened at the lower end. As it is described later, the second conductor 40 is inserted into the groove 31aa from the lower side of the first conductor 30, and thereby the second conductor 40 can be assembled with the first conductor 30 as shown in FIG. 6.

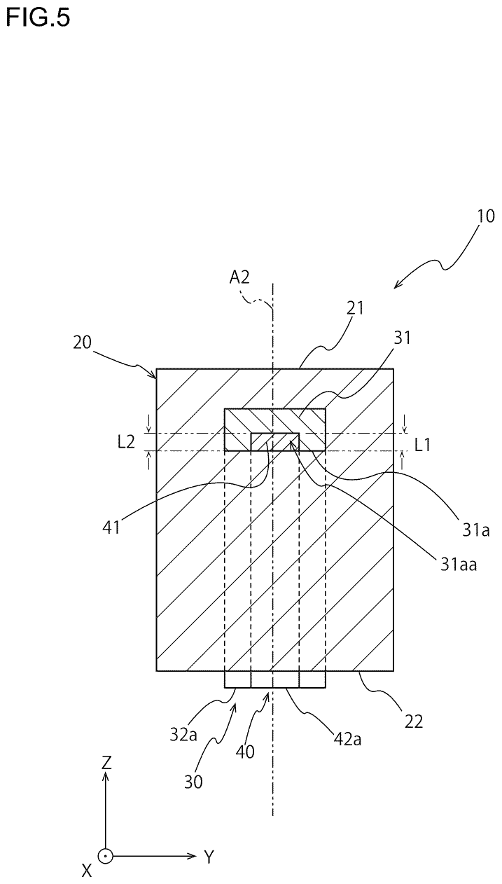

FIG. 5 is a second cross-section view of the coil device 10 shown in FIG. 1. FIG. 5 is the cross-section view observing the coil device 10 from a cross-section which is parallel to the Y-axis and also includes the device center axis A2 parallel to a height direction (Z-axis) running through the center of the coil device 10. As shown in FIG. 5, the groove 31aa includes a cross-sectional shape of roughly rectangle and opened at the inner side, and the groove 31aa accommodates the second coil part 41 of the second conductor 40.

As it can be understood by comparing FIG. 1 and FIG. 6, the lower half of each of the first mounting parts 32a and 32b and parts of the first connecting parts 33a and 33b are exposed downward from the core lower face 22 of the core part 20. Note that, by exposing not only the lower surface of each of the first mounting parts 32a and 32b but also exposing the lateral surface of the first mounting part 32a and parts of the first connecting parts 33a and 33b below the core lower surface 22 of the core part 20, a solder fillet is easily formed during the mounting process, and it is possible firmly mount the coil device on the mounting object.

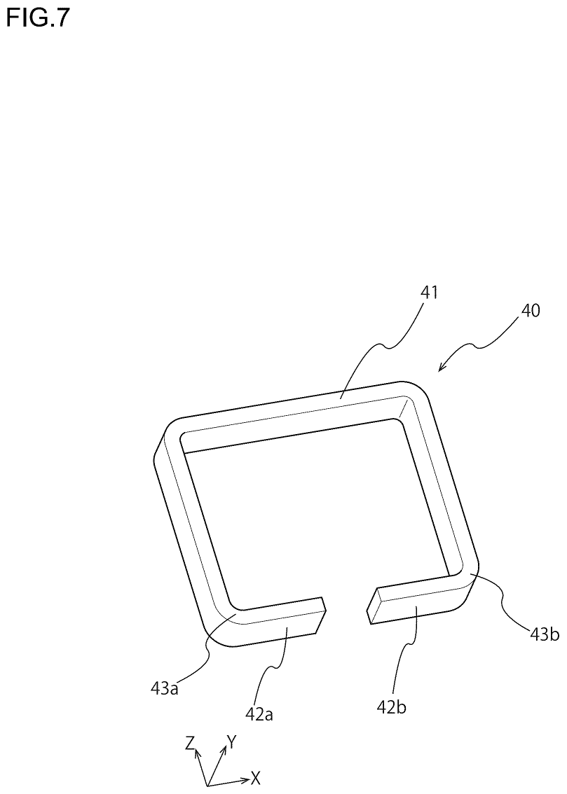

FIG. 7 is a schematic oblique view showing an outer shape of the second conductor 40 included in the coil device 10. As shown in FIG. 4 and FIG. 7, the second conductor 40 includes the second coil part 41 arranged in the core part 20, the second mounting parts 42a and 42b at least partially exposed from the core part 20 and facing the mounting object, and the second connecting parts 43a and 43b connecting the second mounting parts 42a and 42b to the second coil part 41.

As shown in FIG. 4, the second coil part 41 of the second conductor 40 extends along the first coil part 31 at the inner side of the first coil part 31, and the second coil part 41 is adhered on the inner surface 31a and extends in the winding direction 62. As shown in FIG. 4 and FIG. 7, the second conductor 40 is a rectangular ring shape (C-like ring shape) which includes a disconnected part at the lower side when viewed from the Y-axis direction. Materials and a method for producing the second conductor 40 are similar to those described for producing the first conductor 30. Note that, the second conductor 40 and the first conductor 30 may be made of the same materials or different materials.

Although it is not shown in FIG. 4 and FIG. 7, an insulation coating such as a resin may be formed on the surface of the second conductor 40. Note that, as similar to the first conductor 30, the insulation coating of the second conductor 40 is not formed on the lower surfaces of the second mounting parts 42a and 42b. Also, the first coil part 31 and the second coil part 41 may be adhered, however, the first coil part 31 and the second coil part 41 may not directly adhere to each other in the case of placing the adhesive cured part between the first coil part 31 and the second coil part 41 as it will be described later.

As shown in FIG. 4, the two second mounting parts 42a and 42b included in the second conductor 40 configure the lower end portions (the end parts in the Z-axis negative direction side) of the second conductor 40. The second mounting parts 42a and 42b face to each other across the disconnected part of the second conductor 40. One second coil part 41 included in the second conductor 40 configures the portion (a portion in the Z-axis positive direction side) which is located at the upper side than the second mounting parts 42a and 42b and the second connecting parts 43a and 43b of the second conductor 40.

As similar to the first coil part 31, the second coil part 41 has an outer shape of a U-like shape opened downward when viewed from the Y-axis direction. The first coil part 31 surrounds the center area of the coil device 10 from the three-directions which are the upper side, both lateral sides of the X-axis direction. Also, as shown in FIG. 4 and FIG. 6, the first coil 31 and the second coil 41 form a two-layer configuration along the winding direction 62, and the two layers consisting of the first coil part 31 and the second coil part 41 surround the center area of the coil device 10 from the three-directions which are the upper side, both lateral sides of the X-axis direction.

The second mounting part 42a arranged at the X-axis negative direction side with respect to the device center axis A2 is connected to the end part of second coil part 41 in the X-axis negative direction and lower side (Z-axis negative direction), and a second connecting part 43a exists between the second mounting part 42a and the second coil part 41. The second connecting part 43a is bent, and the second mounting part 42a connected to the second connecting part 43a extends toward the device center direction D21 from the second connecting part 43a connected to the second coil part 41.

The second mounting part 42b arranged at the X-axis positive direction side with respect to the device center axis A2 in the second conductor 40 is connected to the end part of second coil part 41 in the X-axis positive direction side and lower side (Z-axis negative direction), and a second connecting part 43b exists between the second mounting part 42b and the second coil part 41. The second connecting part 43b is bent, and the second mounting part 42b connected to the second connecting part 43b extends toward the device center direction D21 from the second connecting part 43b connected to the second coil part 41. Note that, the second conductor 40 has a symmetrical shape across the device center axis A2.

As shown in FIG. 4 to FIG. 6, the second coil part 41 is at least partially embedded inside the groove 31aa of the first coil part 31 and inside the first connecting parts 33a and 33b. As shown in FIG. 5, the second coil part 41 of the coil device 10 has a maximum length L1 in the depth direction of the groove 31aa which is the same length as the maximum length L2 in the depth direction of the groove itself when viewed from the cross-section perpendicular to the winding direction 62 (for example, see FIG. 5).

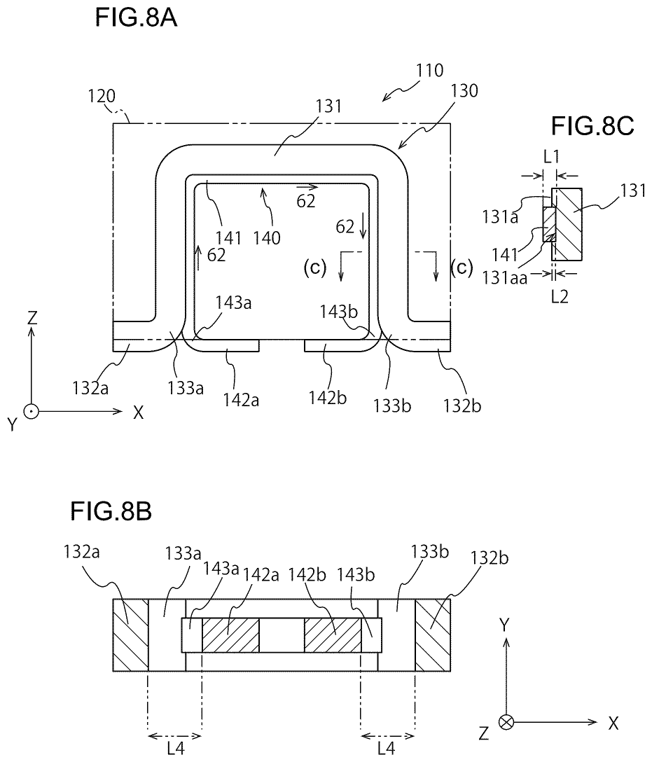

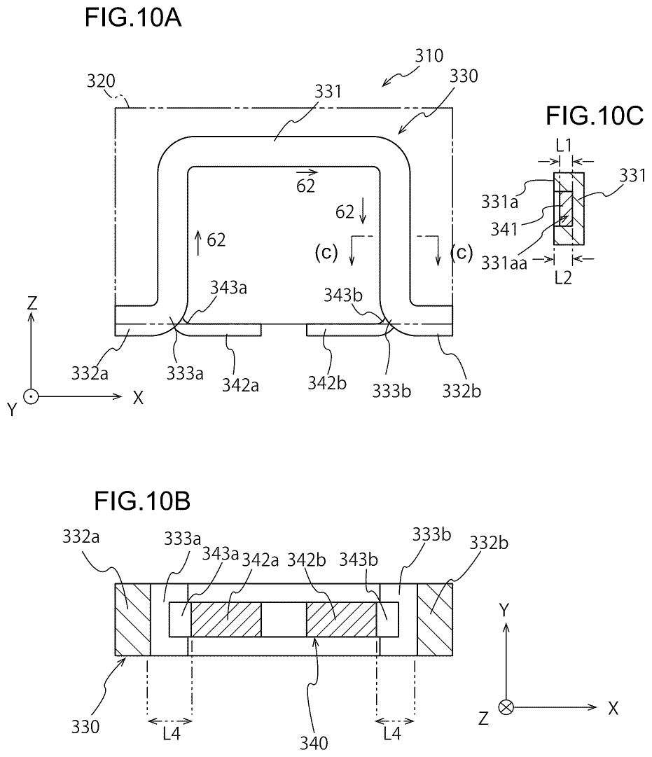

That is, in the coil device 10, the cross-section shape of the second coil part 41 perpendicular to the winding direction 62 is a rectangular shape (for example, see FIG. 5), and the cross-section area roughly matches the cross-section area of the groove 31aa. Note that, the cross-section area of the second coil part 41 perpendicular to the winding direction 62 does not necessarily have to precisely match the cross-section area of the groove 31aa, and the cross-section area of the second coil part 41 may be smaller than or larger than the cross-section area of the groove 31aa (see modified examples shown in FIG. 8 and FIG. 10).

As shown in FIG. 5, the cross-section of the first coil part 31 perpendicular to the winding direction 62 is roughly a rectangular shape except that the groove 31aa is formed to the first coil part 31. Also, the groove 31aa is formed at the center part in the Y-axis direction of the inner surface 31a of the first coil part 31. That is, in the cross-section perpendicular to the winding direction 62, the shapes of the first coil part 31 and the second coil part 41 are both roughly symmetrical across the common symmetrical axis (in FIG. 5, the device center axis A2). Such coil device 10 has the first coil part 31 and the second coil part 41 which are arranged symmetrically; thus, it is possible to suppress property variations which occur within a range of permissible production variation.

Also, in the groove 31aa shown in FIG. 5, the adhesive cured part, which is a part where the adhesive has cured, may be arranged between the first coil part 31 and the second coil part 41. Because the first coil part 31 and the second coil part 41 are firmly fixed due to the adhesive cured part, it is possible to prevent relative position shifting between the first conductor 30 and the second conductor 40 during the molding process of the core part 20.

Also, as shown in FIG. 5, in the cross-section perpendicular to the winding direction 62, the second coil part 41 has a maximum length in the depth direction of the groove 31aa shorter than that of the first coil part 31. The maximum length L1 in the depth direction of the second coil part 41 is shorter than the maximum length L3 in the depth direction of the first coil part 31; thereby, the areas of the first coil part 31 and the second coil part 41 facing each other can be increased, and the electromagnetic coupling between the first conductor 30 and the second conductor 40 can be enhanced.

As shown in FIG. 4, in the coil device 10, throughout the entire second coil part 41 along the winding direction 62, the second coil part 41 is at least partially embedded in the groove 31aa (as shown in FIG. 5, in the first embodiment, most of the second coil part 41 is embedded in the groove 31aa along the winding direction 62). Because the second coil part 41 is embedded inside the groove 31aa throughout the entire second coil part 41 along the winding direction 62, the electromagnetic coupling between the first coil part 31 and the second coil part 41 can be enhanced. Also, it is possible to prevent problems such as magnetic powders entering in the space between the first coil part 31 and the second coil part 41, thereby, it is also possible to effectively prevent problems such as coupling between the first coil part 31 and the second coil part 41 from becoming lower than the design value.

In the coil device 10 explained by using FIG. 1 to FIG. 7, the second coil part 41 is at least partially embedded in the groove 31aa, thereby, the magnetic materials such as metal powders are prevented from entering in the space between the first coil part 31 and the second coil part 41, and it is possible to prevent problems such as coupling between the first coil part 31 and the second coil part 41 from becoming lower than the design value. Also, the second coil part 41 only needs to be arranged along the groove 31aa of the first coil part 31, therefore, the second coil part 41 can be positioned highly precisely with respect to the first coil part 31, and also the space between the first coil part 31 and the second coil part 41 can be prevented from forming, further the relative position of the first conductor 30 and the second conductor 40 can be maintained with high precision.

The coil device 10 explained by using FIG. 1 to FIG. 7 is an embodiment of the coil device 10 according to the present disclosure, and various other embodiments and modified examples are included in the coil device according to the present disclosure. For example, the shapes of the first mounting parts 32a and 32b and the first connecting parts 33a and 33b of the first conductor 30 shown in FIG. 6 are not limited to those shown in FIG. 6; and the first connecting part may be a straight-line shape, and such linear first connecting part may connect the first coil part 31 and the first mounting part in a straight line.

The first conductor having a linear first connecting part 31 has an outer shape of a U-like shape as a whole which is opened downward when viewed from the Y-axis direction. One end face and the other end face of the first conductor both face downward, and each of the end faces face toward the mounting object. The first conductor having the linear first connecting part 31 is a preferable shape in the case that the cross-section area of the first coil part 31 perpendicular to the winding direction 62 is large (for example, the cross-section area of the first coil part 31 is larger by three times or more compared to the cross-section area of the second coil part 41). The first conductor having the linear first connecting part is a simple shape which can be produced easily, and also because the cross-section area is large, the facing area necessary for the mounting object can be ensured by the end faces of the first conductor.

FIG. 8A to 8C are schematic views showing a shape of a coil device 110 according to the first modified example. FIG. 8A is a front view of the coil device 110, FIG. 8B is a cross-section view showing a first coil part 131 and a second coil part 141 perpendicular to the winding direction 62, and FIG. 8C is a bottom view of a first conductor 130 and a second conductor 140. Note that, in the front view of FIG. 8A, a core part 120 is shown in a perspective view, and in FIG. 8C, hatching of diagonal lines is given to the lowermost face of the coil device 110.

The coil device 10 shown in FIG. 1 to FIG. 7 and the coil device 110 are different from the point that in the coil device 110, a maximum length L1 of the second coil part 141 in a depth direction of a groove 131aa is longer than a maximum length L2 of the groove 131aa itself in the depth direction. The schematic structure of the coil device 110 is basically the same as the coil device 10 except that the relative relation of the lengths of the maximum length L1 and the maximum length L2 are different. The coil device 110 will be explained mainly focusing on the differences from the coil device 10, and the common configurations will be omitted from detailed explanation.

As shown in FIG. 8A and FIG. 8B, in the coil device 110, an inner side of the second coil part 141 protrudes out of the groove from the opening of the groove 131aa, and it protrudes toward the inside from the inner surface 131a of the first coil 131. Regarding such coil device 110, compared to the case of without having the groove 131aa, it is possible to suitably prevent problems such as the magnetic powders entering in the space between the first coil part 131 and the second coil part 141. Also, by inserting the second coil part 141 in the groove 131aa, the second coil part 141 can be assembled with high precision to the first conductor 130.

As shown in FIG. 8A, the first connecting parts 133a and 133b of the first conductor 130 are bent, and the first mounting parts 132a and 132b extend toward the device outer side direction. Also, the second connecting parts 143a and 143b of the second conductor 140 are bent, and the second mounting parts 142a and 142b extend toward the center of the device. In such coil device 110, as shown in FIG. 8C, it is possible to widen a space LA between the first mounting parts 132a and 132b which are configuring the lowermost face of the coil device 110 and the second mounting parts 142a and 142b which are similarly configuring the lowermost face of the coil device 110. Therefore, such coil device 110 including the first conductor 130 and the second conductor 140 can even more effectively prevent problems such as short circuits caused by reflow soldering during mounting.

In addition to this, for the common configurations with the coil device 10, the coil device 110 according to the first modified example shown in FIG. 8 exhibits the same effects as the coil device 10.

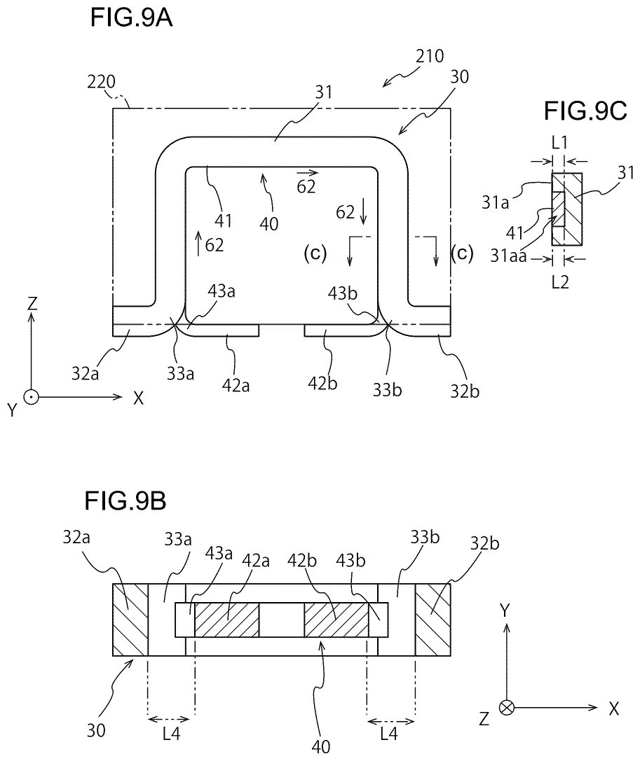

FIG. 9A to FIG. 9C are schematic views showing a shape of a coil device 210 according to the second modified example. FIG. 9A is a front view of the coil device 210, FIG. 9B is a cross-section view showing a first coil part 31 and a second coil part 41 perpendicular to the winding direction 62, and FIG. 9C is a bottom view of a first conductor 30 and a second conductor 40. Note that, in the front view of FIG. 9A, a core part 220 is shown in a perspective view, and in FIG. 9C, hatching of diagonal lines is given to the lowermost face of the coil device 210.

The coil device 210 and the coil device 10 shown in FIG. 1 to FIG. 7 are basically the same except that a thickness of the core part 220 (the Y-axis direction length) of the coil device 210 is different. That is, a maximum length L1 of the second coil part 31 in the depth direction of the groove 31aa is about the same as the maximum length L2 of the groove 31aa itself in the depth direction.

Compared to the coil device 110 in which the second coil part 141 partially protrudes out from the groove 31aa as shown in FIG. 8A to FIG. 8C, the coil device 210 tends to easily increase a coupling coefficient K between the first conductor 30 and the second conductor 40. Also, since there is less height difference on the surface when the first conductor 30 and the second conductor 40 are assembled, a compact coil device 210 can be achieved while suppressing the electric resistance value. Also, the coil device 210 attains the same effects as the coil device 10.

FIG. 10A to FIG. 10C are schematic views showing a shape of a coil device 310 according to the third modified example. FIG. 10A is a front view of the coil device 310, FIG. 10B is a cross-section view showing a first coil part 331 and a second coil part 341 perpendicular to the winding direction 62, and FIG. 10C is a bottom view of a first conductor 330 and a second conductor 340. Note that, in the front view of FIG. 10A, a core part 320 is shown in a perspective view, and in FIG. 10C, hatching of diagonal lines is given to the lowermost face of the coil device 310.

The coil device 310 is different from the coil device 10 shown in FIG. 1 to FIG. 7 from the point that a maximum length L1 of the second coil part 341 in the depth direction of a groove 331aa is shorter than a maximum length L2 of the groove 331aa itself in the depth direction. The schematic structure of the coil device 310 is basically the same as the coil device 10 except that the relative relation of the lengths of the maximum length L1 and the maximum length L2 are different. The coil device 310 will be explained mainly focusing on the differences from the coil device 10, and the configurations which are in common with the coil device 10 will be omitted from detailed explanation.

As shown in FIG. 10A and FIG. 10B, in the coil device 310, the inner side of the second coil part 341 is arranged to the inside of the groove from the opening of the groove 331aa, and it is embedded to the inside from the inner surface 331a of the first coil 331. Such coil device 310 can also suitably prevent problems such as the magnetic powders entering inside the space between the first coil part 331 and the second coil part 341 which is accommodated in the groove 331aa. Also, by inserting the second coil part 341 in the groove 331aa, the second conductor 340 can be assembled to the first conductor 330 with high precision.

As shown in FIG. 10B, the first mounting parts 332a and 332b, the first connecting parts 333a and 333b, the second mounting parts 342a and 342b, and the second connecting parts 343a and 343b are basically the same as the second modified examples shown in FIG. 9B. In addition to this, for the configurations which are in common with the coil device 10, the coil device 310 according to the third modified example shown in FIG. 10 exhibits the same effects as the coil device 10.

As described in above, following is disclosed in the present specification.

### Reference Note 1

A coil device comprising:
a core part including a metal powder and a resin;
a first conductor comprising a first coil part arranged inside the core part, a first mounting part at least partially exposed from the core part and faces a mounting object, and a first connecting part connecting the first coil part and the first mounting part; and
a second conductor comprising a second coil part arranged inside the core part, a second mounting part at least partially exposed from the core part and faces the mounting object, and a second connecting part connecting the first coil part and the first mounting part;
wherein, a groove is formed to an inner surface of the first coil part along a winding direction,
the second coil part extends along the winding direction of the first coil part at an inside of the first coil part, and
the second coil part is at least partially arranged inside the groove of the first coil part.

### Reference Note 2

The coil device according to Reference note 1, wherein at least part of the entire second coil part in the winding direction is embedded inside the groove.

### Reference Note 3

The coil device according to Reference note 1 or 2, wherein an adhesive cured part formed by curing an adhesive is arranged between the first coil part and the second coil part in the groove.

### Reference Note 4

The coil device according to any one of Reference notes 1 to 3, wherein the first coil part and the second coil part are shaped roughly symmetrical across a common symmetrical axis in a cross-section perpendicular to the winding direction.

### Reference Note 5

The coil device according to any one of Reference notes 1 to 4, wherein a maximum length of the second coil part in a depth direction of the groove is shorter than a maximum length of the first coil part in the depth direction of the groove in the cross-section perpendicular to the winding direction.

### Reference Note 6

The coil device according to any one of Reference notes 1 to 5, wherein the first connecting part is a straight-line shape and connects the first coil part and the first mounting part in a straight line; and
the second connecting part is bent and the second mounting part connected to the second connecting part extends toward a center of the coil device with respect to the second connecting part connecting to the second coil part.

### Reference Note 7

The coil device according to any one of Reference notes 1 to 6, wherein the first connecting part is bent, and the first mounting part connected to the first connecting part extends toward outside of the coil device with respect to the first connecting part connecting to the first coil part, and
the second connecting part is bent, and the second mounting part connected to the second connecting part extends toward a center of the coil device with respect to the second connecting part connecting to the second coil part.

### Reference Note 8

The coil device according to any one of Reference notes 1 to 7, wherein a maximum length of the second coil part in a depth direction of the groove is equal to or longer than a maximum length of the groove itself in the depth direction in a cross-section perpendicular to the winding direction of the second coil part.

### Reference Note 9

The coil device according to any one of Reference notes 1 to 8, wherein a maximum length of the second coil part in a depth direction of the groove is shorter than a maximum length of the groove itself in the depth direction in a cross-section perpendicular to the winding direction of the second coil part.

### REFERENCE SIGNS LISTS

10, 110, 210, 310 . . . Coil device
20, 120, 220, 320 . . . Core part
21 . . . Core upper surface
22 . . . Core lower surface
23 . . . First outer lateral surface
24 . . . Second outer lateral surface
25 . . . Third outer lateral surface
26 . . . Fourth outer lateral surface
D21 . . . Device center side
D22 . . . Device outer side direction
A2 . . . Device center axis
30, 130, 330 . . . First conductor
31, 131, 331 . . . First coil part
31a, 131a, 331a . . . Inner surface
31aa, 131aa, 331aa . . . Groove
62 . . . Winding direction
32a, 32b, 132a, 132b, 332a, 332b . . . First mounting part
33a, 33b, 133a, 133b, 333a, 333b . . . First connecting part
40, 140 240, 340 . . . Second conductor
41, 141, 241, 341 . . . Second coil part
42a, 42b, 142a, 142b, 342a, 342b . . . Second mounting part
43a, 43b, 143a, 143b, 343a, 343b . . . Second connecting part
L1, L2, L3 . . . Length
L4 . . . Space

What is claimed is:

1. A coil device comprising:
a core part including a metal powder and a resin;
a first conductor comprising a first coil part arranged inside the core part, a first mounting part at least partially exposed from the core part and faces a mounting object, and a first connecting part connecting the first coil part and the first mounting part; and
a second conductor comprising a second coil part arranged inside the core part, a second mounting part at least partially exposed from the core part and faces the mounting object, and a second connecting part connecting the first coil part and the first mounting part;
wherein, a groove is formed to an inner surface of the first coil part along a winding direction,
the second coil part extends along the winding direction of the first coil part at an inside of the first coil part, and
the second coil part is at least partially arranged inside the groove of the first coil part.

2. The coil device according to claim 1, wherein at least part of the entire second coil part in the winding direction is embedded inside the groove.

3. The coil device according to claim 1, wherein an adhesive cured part formed by curing an adhesive is arranged between the first coil part and the second coil part in the groove.

4. The coil device according to claim 1, wherein the first coil part and the second coil part are shaped roughly symmetrical across a common symmetrical axis in a cross-section perpendicular to the winding direction.

5. The coil device according to claim 1, wherein a maximum length of the second coil part in a depth direction of the groove is shorter than a maximum length of the first coil part in the depth direction of the groove in the cross-section perpendicular to the winding direction.

6. The coil device according to claim 1, wherein the first connecting part is a straight-line shape and connects the first coil part and the first mounting part in a straight line; and
the second connecting part is bent and the second mounting part connected to the second connecting part extends toward a center of the coil device with respect to the second connecting part connecting to the second coil part.

7. The coil device according to claim 1, wherein the first connecting part is bent, and the first mounting part connected to the first connecting part extends toward outside of the coil device with respect to the first connecting part connecting to the first coil part, and
the second connecting part is bent, and the second mounting part connected to the second connecting part extends toward a center of the coil device with respect to the second connecting part connecting to the second coil part.

8. The coil device according to claim 1, wherein a maximum length of the second coil part in a depth direction of the groove is equal to or longer than a maximum length of the groove itself in the depth direction in a cross-section perpendicular to the winding direction of the second coil part.

9. The coil device according to claim 1, wherein a maximum length of the second coil part in a depth direction of the groove is shorter than a maximum length of the groove itself in the depth direction in a cross-section perpendicular to the winding direction of the second coil part.
